(19) United States
(12) Patent Application Publication
(10) Pub. No.: US 2007/0191090 A1
(43) Pub. Date: Aug. 16, 2007

(54) Slot machine with a locking function

(75) Inventors: Terry O'Halloran, Paddington (AU); William J. Hardy, Queensland (AU)

Correspondence Address: Mark A. Litman & Associates, P.A.;York Business Center, Suite 205, 3209 West 76th Street, Edina, MN, 55435, US

(73) Assignee: Stargames Corporation Party Limited

(21) Appl. No.: 11/637,225

(22) Filed: Dec. 11, 2006

(30) Foreign Application Priority Data
Dec. 12, 2005 (AU) 2005906972

(51) Int. Cl. A63F 13/00

(52) U.S. Cl. 463/20

(57) ABSTRACT

An electronic gaming machine includes a control processor programmed to initiate an optional lock function. This lock function enables a player a) to “lock” the machine through a touchscreen data entry or button data entry upon entry of a code prior to activating the lockout and while the machine contains credits, and b) to unlock the machine through data entry of the same code.

### RELATED APPLICATIONS DATA SECTION

This application claims priority under 35 USC 119 from Australian Provisional Application Ser. No. AU 2005/906972, filed Dec. 12, 2005.

### BACKGROUND OF THE INVENTION

This invention relates to a method and arrangement for enabling a player of a slot machine to “lock” or reserve the machine.

Slot machines include cash inputs and payout mechanisms which are designed to permit the rapid transfer of money into or out of the machine. This provides players with the ability to move between machines in accordance with their preferences for the different games or for other reasons.

Slot machines are provided at various venues in several countries. In some venues, particularly during peak periods, the venues can become crowded to the extent that there are more people wishing to play the machines than there are machines. In addition, a player may wish to have a break from the machine he or she is playing. Furthermore, some players have a preference for a particular machine.

Generally when a player leaves a machine, the machine is free for another player to use it. However, some times a player may wish to leave the machine for a short period and then return to it. In current machines, the security of the player's money in the machine cannot be guaranteed if the player leaves the machine with money in it.

In the past, when a player was playing a machine and wished to take a break, the player would sometimes place an object in the coin tray or in the cash input as an indication that the player wishes to reserve the machine. Some machines were provided with “Reserved” flaps to cover the cash input. However, it quite often happened that the player would not return to the machine, and the machine would be left idle for a considerable time, and this could significantly decrease the turnover of the machine.

Alternatively, where a player wished to leave the machine for a short time while the machine money in it, the player would need to either take the money out of the machine or ask someone to look after the machine.

Certain locking functions are recognized in the slot gaming field. In U.S. Pat. No. 5,611,730 (Weiss) there is disclosed both a physical lock provided on cabinet doors and an electronic lock-out or soft tilt automatically imposed upon the system when certain events occur. One feature in the Weiss system is the soft tilt or soft lockout function. When a slot machine microcontroller assembly can no longer verify the current jackpot amount, it will render the game unplayable yet still allow customers to cash out their credit balances. The soft lockout condition is most probably due to a prolonged loss of communications between either the slot machine microcontroller assembly or the bank controller, between the bank controller and the casino site master controller, or between the casino site master controller and the file server/polling computer. Other errors or problems can also trigger engagement of the lock-out function, including a winning event or jackpot.

U.S. Pat. No. 5,429,329 (Raven et al.) describes monitoring of slot machines and especially controls exercised on coin hoppers, including locks on the system. A lockout connector is provided on the MASTERCOM 14. By connecting the MASTERCOM 14 to the coin mechanism of the gaming machine, it is possible to lockout, or reject, all coins inserted into the machine.

U.S. Pat. No. 5,344,144 (Canon) describes problem in automatic lock-ups in progressive systems wherein some types of multiple jackpot systems also experienced so-called “lock-up” which occurred when a large number of jackpots were hit over a relatively short span of time. Thus, as the progressive systems added more levels of jackpots and increased the number of gaming devices connected to a single jackpot, the hit frequency increased and resulted in situations where the entire progressive system “locked up”, due to many jackpots awaiting completion of their payout. This situation resulted from the use in the progressive system accumulator of a jackpot payout queue or stack which operated on a first-in first-out basis and which “locked-up” the entire progressive system when all stack positions storing payouts to be completed became filled. This occurred, even if a jackpot in the middle of the stack had been paid out, since its position in the stack could not be immediately cleared and made available to another jackpot. This caused the stack to “lock-up” the gaming system at a greater frequency than was desired.

U.S. Pat. No. 5,326,104 (Pease et al.) describes an automatic warning system (AWS) that locks up slot devices when warning signals are provided to the system. If the Call Attendant key is pressed on an AWS the security monitor will emit one beep to alert a security operator. When a bonus prize is won, the security monitor will emit three beeps, and display all pertinent information including the AWS number and identification, the player account number, the win description, the pick/catch combination, game number and time. Should a Handpay amount be won, the Security Monitor will emit a loud siren warning tone and the winning AWS will be locked up to prevent further activity until the Handpay win is paid and cleared. A Manager authorization code must be entered on a workstation to clear the Handpay Prize, and a specially punched Handpay Clear card must be inserted into the AWS to unlock it for further activity.

Similarly U.S. Pat. No. 5,249,800 (Hilgendorf) and U.S. Pat. No. 5,113,990 (Gabrius) show automatic or casino initiated lock-outs of progressive gaming systems when one of more jackpots are awarded. In Hilgendorf, for instance, if it is desired to lock up all of the gaming machines in the event certain jackpots occur, such as a super jackpot, the enable line can be used to disable or lock-up all of the machines until this jackpot has been paid. Also, if there is a fault in the progressive controller or communication between the progressive controller and the communication unit, the communication unit can use the enable line to disable all of the games to stop play until the fault is remedied.

Additional references such as U.S. Pat. No. 4,837,728 (Barrie) disclose automatic lock-ups when jackpot events or errors occur.

U.S. Pat. No. 4,636,951 (Harlick) describes automatic commands that function with a list of command characters used in the system as follows: “C” Command Listing Description A Opto-Audit data is required (and cleared) S Opto-Audit data is required I Sending credit to machine. Actual value will follow this letter. D Collect any remaining credit on the machine. (same as COLLECT button but data is sent to the change booth) Z Machine lockup, needed until the player can get back to the machine. R Release the machine ready for playing. J Jackpot reset Q Cancel Credit reset F Flash mode to identify a machine. Thus, an automatic lock-up I and its command language is described.

U.S. Published Patent Applications Nos. 20060223629 and 20060217190 (Walker et al.) describes a process for playing slot machines in which a contract is established between a player and the device/system for a defined type or extent of play. [0145] A typical contract may cover and/or require a large number of handle pulls by the player. Ordinarily, when a player is gambling at a gaming device for a long period of time, the player makes a number of decisions related to his gambling. For example: Should the player play more quickly or more slowly? Should the player double his bet after a loss? Should the player quit after a sizable win? Should the player take a short break to use the restroom? Since the contract may cover a large number of handle pulls, it is possible for the some player decisions to be made beforehand and included in the contract. A gaming device may then act on the decisions specified in the contract without further input from the player. For example, while negotiating a contract for an hour of play at ten pulls per minute, a player might decide he would like a fifteen minute break between the first half-hour and the second half-hour of pulls. The gaming device might then execute the contract for the first half-hour by automatically spinning and generating outcomes for the first half-hour. The gaming device might then freeze or lock up for fifteen minutes, preventing other players from stepping in and allowing the contract holding player to take his fifteen minute break. The device can then unlock after fifteen minutes, perhaps with the entry of a password, and resume the generation of outcomes.

U.S. Published patent Application 20020132666 (Lind) describes another automatic lock-out system. The transfer of game record subsets to the central computers is performed so as to ensure game records are quickly available at the central computer to service any game play request. It may also be desirable to include additional features to ensure that a game may not be commenced at a player terminal unless the central computer may completely service the request. According to one form of gaming system 10, the central computers monitor each game subset that they store. If a predetermined minimum number of game records is reached in a game record subset without a reserve or backup subset being ready, the central computer may lock out the game that uses the particular record subset. This lockout is preferably accomplished by communicating a suitable game lockout message to each player terminal programmed with that particular game. The player terminal responds to the lockout message by making the particular game unavailable to a player who may log in at the terminal. Alternatively, the player terminal may simply not allow a player to log in at the terminal by not responding to an inserted player card and producing a display showing that the terminal is not available.

Published U.S. Patent Applications Nos. 20060217188; 20060217187; 20060211493; 20060178189; 20030003988; 20020151366; and 20060211489 (Walker et al.) shows a system wherein a player can impose restraints on the play of the game. For example, FIG. 4C shows one embodiment of a customization and constraint menu 4C10 wherein constraint choices 440 provide the player the opportunity to apply constraints to one or more elements. If selected, a “lock” constraint, such as that illustrated at 442, may force the value of the corresponding element to remain at its current value. For example, in FIG. 4C, the “lock” button 441 corresponding to the outcome “7-7-7” has been selected, as indicated by the highlighting of the button's border. Therefore, the payout of the outcome “7-7-7” may be constrained to remain at the “current value” 416 of 100. Also, if selected, a “require” constraint, such as that illustrated at 444, may force the value of the corresponding element to be altered. For example, if a player were to selected the “require” constraint 444, then the player may thereby force of the payout of the outcome “cherry-cherry-cherry” to change from its “current value” 416 of 20, to some other value. In one embodiment, menu 4C10 may be accessed through the selection of the “payout” option 312 in the menu illustrated in FIG. 3B.

Each of the references cited herein are incorporated by reference in their entirety for the full extent of their technical disclosure and to provide instruction as to circuit, logic, hardware and software useful in practices of technology described in the present invention.

### SUMMARY OF THE INVENTION

This invention provides a system and method whereby a player can “lock” or reserve a particular machine (e.g., automated wagering machine, such as a slot machine, reel-type machine, blackjack machine, poker machine, roulette machine, craps machine, or other wagering game machine) or play position on a bank of machines or a multi-player platform such as those described in Published U.S. Patent Applications Nos. 20050164759; and 20050164762 while there are still credits in the machine. Preferably, the machine can be locked for up to a predetermined period of time or preset.

According to one embodiment of the invention, there is provided a method of operating a slot machine wherein the player can “lock” or reserve a particular casino wagering machine while the machine contains credits.

A further embodiment of the invention provides a wagering machine such as a slot machine having a screen and an input panel having one or more player input buttons or player input areas on a touchscreen system; the slot machine including a processor and associated program store including a program operated locking or machine-reserving function.

The slot machine can include a lock function button or touchscreen area to initiate the lock function.

The machine can be locked can be locked and/or unlocked using an access code. The access code can be a PIN code, and machine can be provided with a code input means. The code input means can be a keyboard. The keyboard can be provided as a touch screen display. The keyboard screen display may be operated by a function button. The function button can be a touch screen button.

The machine may be designed so as to be locked/unlocked by the use of an information carrier and reader.

### BRIEF DESCRIPTION OF THE DRAWINGS

FIG. 1 shows a slot machine;

FIG. 2 shows a first screen display;

FIG. 3 shows the screen display after a player has actuated the RESERVE function;

FIG. 4 shows a third screen display;

FIG. 5 shows a fourth screen display;

FIG. 6 shows a sixth screen display;

FIG. 7 shows a flow diagram of a process implementing an embodiment of the invention.

FIG. 8 shows an alternative embodiment of a slot machine.

### DETAILED DESCRIPTION OF THE INVENTION

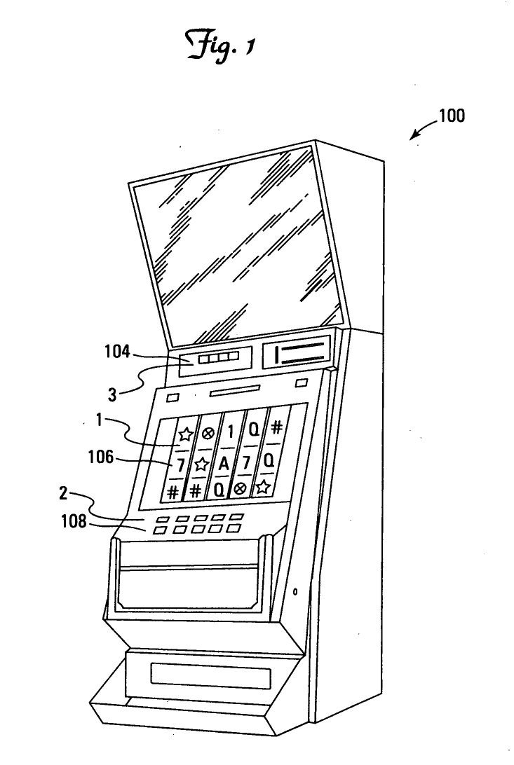

FIG. 1 shows a slot machine 100, having a display 102, a function button panel 108 and a game display 106. Cash and/or card inputs are also provided to enable the player to buy game credits to play on the machine.

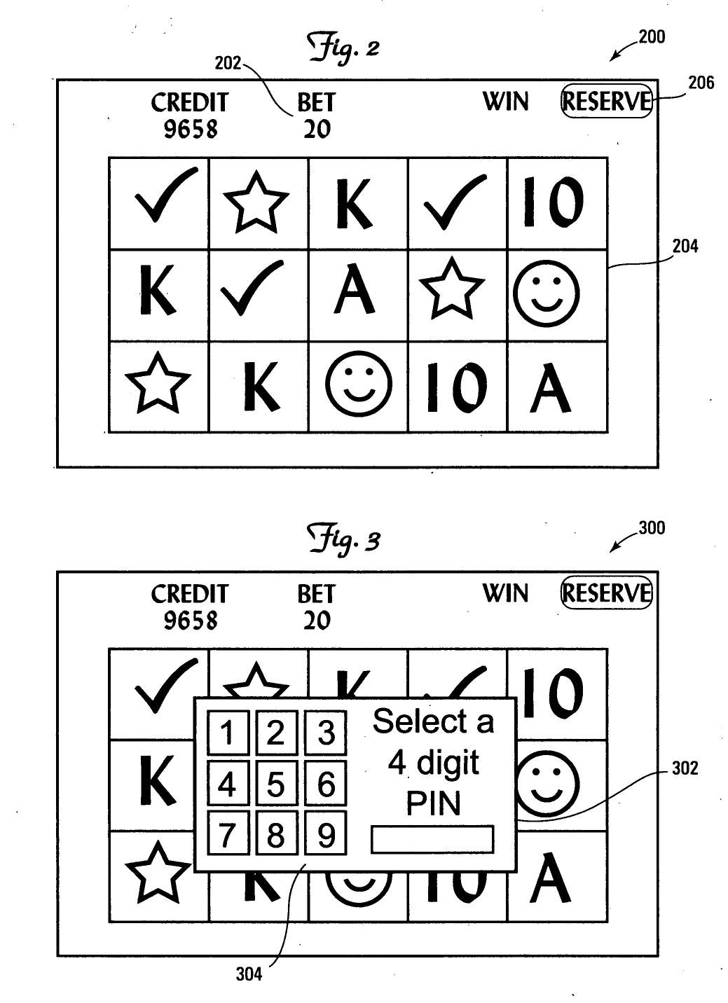

FIG. 2 shows a first screen display 200 having an information display area 202, and a three row, five column game display area 204. In this embodiment, a RESERVE button 206 in the form of a touch screen button is shown on the display 200. It is preferred that a RESERVE function or game lock-out function can be initiated by a player at a machine only when there are credits available for play on the machine, and possibly with a predetermined minimum number of credits available for play (e.g., at least a specific number or value of credits, such as at least 10 credits or at least $5.00 in credits). This will prevent players from locking-up or reserving machines without placing credit under control of the machine. It is possible that, even if no credits are available, a player with a player's card or a player willing to pay for the service, may pay specifically for the reservation (e.g., $1.00 for 10 minutes) if the player wishes to, or if the player has a rated player's card or wishes to use comps through the card, the player can reserve the machine for a time certain using that value mechanism.

The information display area can contain status information such as the available game credits, the current bet value and the number of credits won on the most recently completed game.

The processor controlling the operation of the slot machine, preferably checks that the slot machine contains games credits and, where the machine contains credits, the RESERVE function is activated. A means for indicating that the RESERVE button is active can be provided. For example, the RESERVE button may flash or may be lit or coloured a first colour.

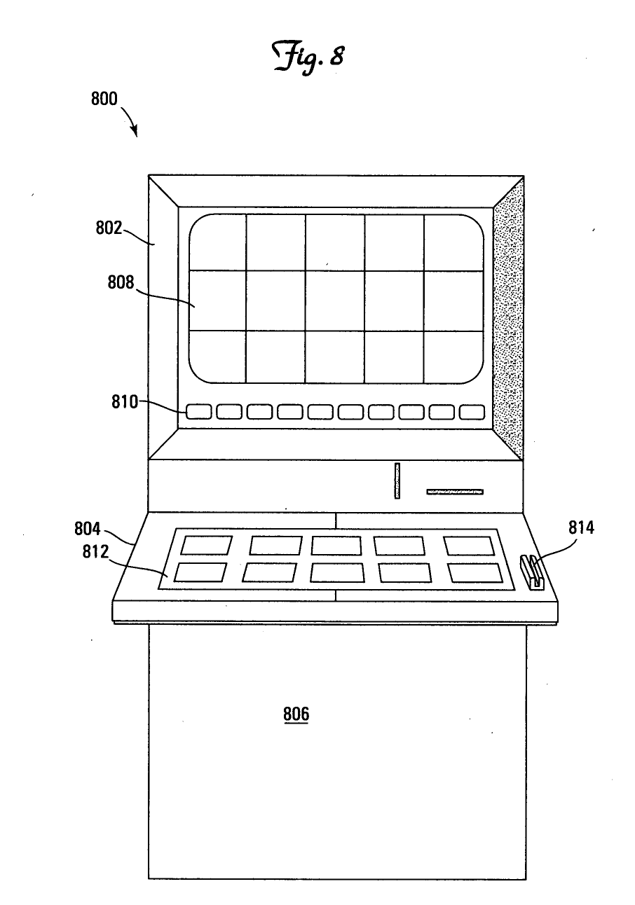

The player can initiate a reserve function by operating the RESERVE button. While the button in this embodiment is a touch screen button, it can alternatively be a button on the function button panel. In a further embodiment, the reserve function can be initiated by the player inserting an information carrier into a reader such as the optional magnetic card reader shown at 814 in FIG. 8. In the format where a player is wagering on a machine through a remote control device, a player may even be able to hit the reserve button and when a player at that machine has finished the round, the remote player may have reserved the machine for hims;ef/herself by activation of the remote controlled reserve function. The player then need only identify the player to the machine (e.g., through the remote device or a players card input to the machine or for any other player input identifying a particular player) and the player can then have access to the machine for play.

If there are no credits in the machine, the reserve function can be disabled by the processor. Again, the unavailability of the reserve function can by indicated visually, either by a dull or non-highlighted image, a ghost image, mere lack of appearance on the screen, a red circle with a line through it, or any other indicator.

FIG. 3 shows an embodiment of the screen display after the player initiates the reserve function.

In this displayed embodiment, an input code touch screen display 302 is superimposed on the game screen. While a simple numeric keypad display 304 is shown, an alphanumeric keypad or a keypad having other symbol inputs can be used, so that the code can be numbers, letters, symbols or a combination of these. Alternatively, the code may be selected by a sequence of one or more function buttons. A biometric identification solution may also be provided, as with fingerprints, retinal scan, facial scan or the like. Data entry through magnetic stripe cards, smart cards, personal cell phones, PDAs, or other electronic instrumentation may also be performed.

The display 302 requests the player to select a code. The player can select a code by using the keypad 304 or enter information in response to the request by any other available data entry methodology.

If the player does not enter the code correctly, for example by entering a three number code when a four number code is required, the display can again request the player to enter a four pin code or provide other appropriate information.

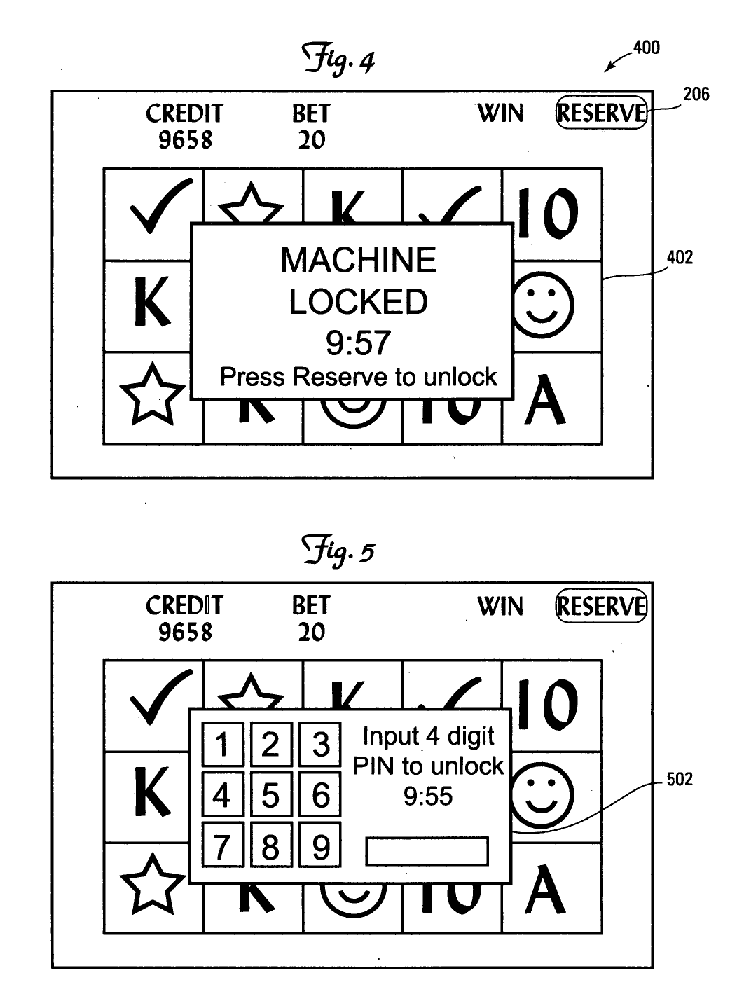

If the player correctly enters the code, the display changes to that shown in FIG. 4. The superimposed display 402 displays a message “Machine Locked”. The display can also provide a time indication which may indicate one or more of:
the time when the machine was locked;
the time when the lock will automatically release; or
the time remaining before the machine automatically unlocks.

By having the “Machine Locked” message superimposed on the game area of the screen, other people wishing to play the machine can quickly see that the machine is not available.

The display also requests the player to press the RESERVE button to initiate the unlocking of the machine.

If the player presses the RESERVE button before the lock function times out, the superimposed display changes to that shown at 502 in FIG. 5. The display can be similar to that shown in FIG. 3 and incorporates the input keypad.

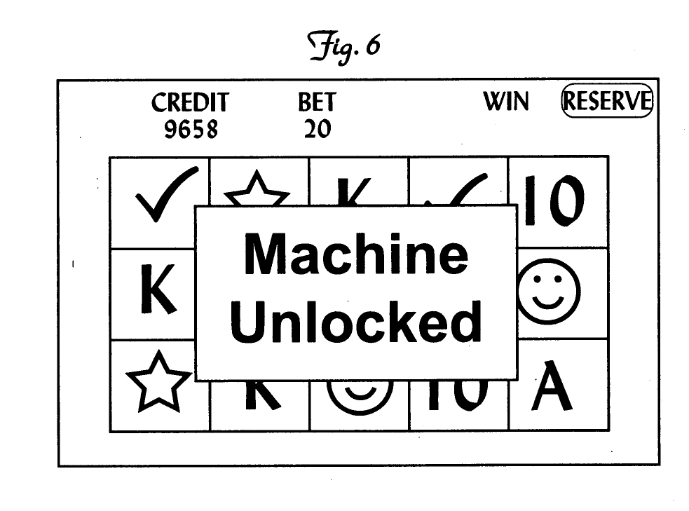

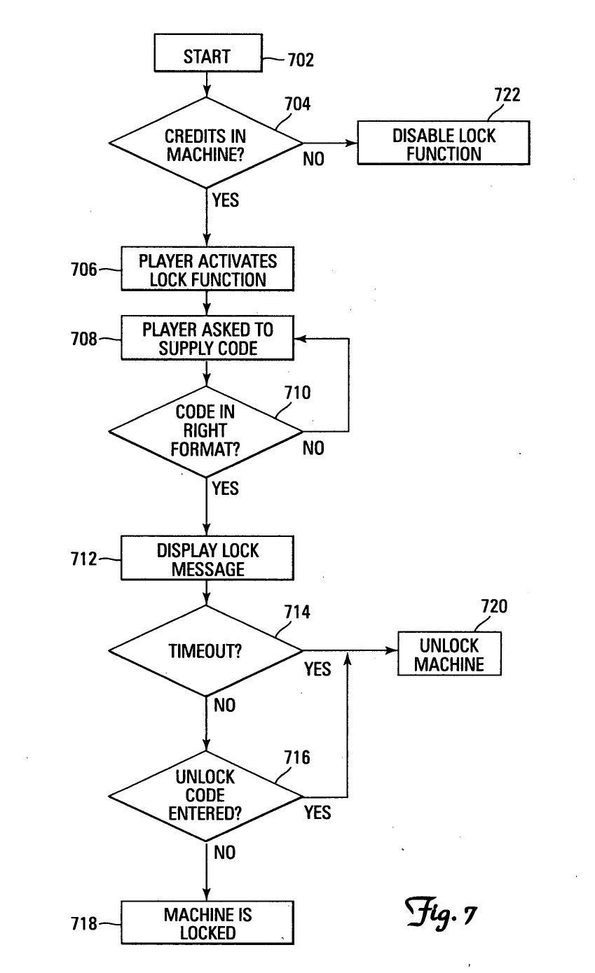

If the player enters the correct code, the superimposed display can change to that shown in FIG. 6 to indicate that the machine has been unlocked. This message will time out after a short period. Alternatively, the superimposed display can simply be removed when the machine is unlocked.

FIG. 7 illustrates a flow diagram of a method of locking a slot machine according to an embodiment of the invention.

The processor continuously checks whether there are credits in the machine at step 704.

If there are no credits, the locking function is inhibited. The LOCK button may not be illuminated. An error message, such as “ZERO CREDIT-LOCK UNAVAILABLE” may be displayed on the screen (not shown).

If there are credits available, the lock function is enabled at 702, and the LOCK button, either on the button panel or on the touch screen is illuminated to indicate the availability of the LOCK function.

When the player operates the LOCK button, a message requesting the player to enter a code, referred to herein as a PIN, can appear on the screen or the button panel. The panel or screen may also identify periods of time over which the player may be allowed to reserve the machine, such as 5 minutes, 10 minutes, 15 minutes, 30 minutes, or the like. It is also possible for a player to reserve a machine through this system for a later time period, such as 60 minutes later or 90 minutes later, which would allow the player to go to a meal or the like. A notice could appear on the screen in the interim indicating to a subsequent or intermediate player that the system has been reserved for a particular time frame. A clock system in the hardware could indicate running time until expected return of the reserving player or a specific time (e.g., 6:45 p.m.) when the reserving player is expected back. The system may provide alerts to the intermediate player as the elapsing or approaching time nears, so that the machine is not shut down unexpectedly for the intermediate player. It is also possible that the machine will continue to allow an intermediate player to continue play until the reserving player communicates with the machine to enable access for the reserving player.

If the player enters the PIN incorrectly, a message requesting the player to enter the PIN is displayed again.

When the player enters the PIN correctly, the processor displays a LOCKED message.

The LOCKED massage may contain an instruction as to how to unlock the machine. Where a PIN is used to lock the machine, the message may instruct the user to enter the PIN.

Alternatives can be a simple message to press a specific button such as UNLOCK or RESERVE. Where the machine has been locked by a record carrier, the message will instruct the use of the information carrier to unlock the machine.

While the LOCKED message is displayed, the processor checks for the time limit to expire.

When the time limit expires, the machine is unlocked.

However, if the player wishes to reactivate the machine before the time limit expires, the player can implement the displayed instruction to unlock the machine.

FIG. 8 illustrates an alternative machine arrangement 800 to that illustrated in FIG. 1. The machine has a screen 802, a button panel 804 with a button array 812.

An optional reader 814 can be used to read an information carrier.

The term “information carrier” includes forms of information record such as magnetic strip card, smart card, flash memory or other alternative information carriers.

Although specific examples and specific apparatus or components are referenced, the technology has been generally described in generic terms and the specific examples should not be read as an attempt to limit the scope of the disclosure or the claims to those examples.

1. (canceled)

2. A slot machine having a screen and an input panel having one or more input buttons;
the slot machine including a processor and associated program store including a program operated locking function.

3. A slot machine as claimed in claim 2 including a lock function button to initiate the lock function.

4. A slot machine as claimed in claim 2 wherein the machine can be locked using an access code.

5. A slot machine as claimed in claim 2 wherein the machine can be unlocked using the access code.

6. A slot machine as claimed in claim 4 wherein the access code is a PIN code.

7. A slot machine as in claim 2 wherein the machine is provided with access from a system that can in put code into the program operated locking function.

8. A slot machine as claim 2 wherein the program operated locking function is accessible through a keyboard to input code.

9. A slot machine as claim 8 wherein the keyboard is a touch screen display.

10. A slot machine as in claim 8 wherein the keyboard comprises a screen display operated by a function button.

11. A slot machine as claimed in claim 10, wherein the function button is a touch screen button.

12. A slot machine as claimed in claim 2 wherein the machine can be locked/unlocked by the use of an information carrier and reader.

13. A method of providing a reserve function in a slot machine, including the steps of:
verifying the presence of game credits in the machine; and
enabling a slot machine reservation function when there are credits present.

14. A method as claimed in claim 13, including providing a visual indication that the slot machine reservation function is enabled.

15. A method as claimed in claim 13 including:
requesting a player to enter a code; and
locking the machine when the code is entered.

16. A method as claimed in claim 13 further including providing a masking display over the game display when the reserve function has been activated.

17. The slot machine of claim 2 further including a control processor programmed to initiate an optional lock function whereby a player using the slot machine can reserve the machine while the machine contains credits at any time during play by the player of the slot machine.

18. The slot machine of claim 2 further including a control processor programmed to initiate an optional lock function whereby
a) a player can reserve the machine through a touchscreen data entry or button data entry upon entry of a code prior to activating the lockout and while the machine contains credits, and
b) the player can unlock the machine through data entry of the same code.

19. An electronic gaming machine including a control processor programmed to allow any first player playing on the electronic gaming machine on credit registered on the gaming machine to initiate an optional lock function whereby that first player can lock out other players from the machine for a period of time while the machine contains credits and the program allows the first player to subsequently unlock the machine.

20. The electronic gaming machine of claim 19 wherein the lock function is enabled for the first player solely by the presence of registered credit on the machine and without prior contracting.

21. The slot machine of claim 17 wherein the player may engage the lock function without prior contractual commitment to time on the slot machine.
